(19) United States
(12) Patent Application Publication
(10) Pub. No.: US 2024/0173703 A1
(43) Pub. Date: May 30, 2024

(54) Platinum-Palladium Bimetallic Hydrocracking Catalyst

(71) Applicant: CHEVRON U.S.A. INC., San Ramon, CA (US)

(72) Inventors: Trenton James OTTO, Mountain View, CA (US); Bi-Zeng ZHAN, Albany, CA (US)

(73) Assignee: CHEVRON U.S.A. INC., San Ramon, CA (US)

(21) Appl. No.: 18/552,176

(22) PCT Filed: Mar. 21, 2022
(86) PCT No.: PCT/US2022/021109

§ 371 Date: Sep. 23, 2023

Related U.S. Application Data
(60) Provisional application No. 63/165,016, filed on Mar. 23, 2021.

(51) Int. Cl. B01J 29/12; B01J 21/04; B01J 21/12; B01J 23/44; B01J 29/08; B01J 37/02; B01J 37/08; C10G 47/18

(52) U.S. Cl. CPC B01J 29/126; B01J 21/04; B01J 21/12; B01J 23/44; B01J 29/084; B01J 37/0201; B01J 37/0236; B01J 37/088; C10G 47/18; C10G 2300/202; C10G 2400/08

(57) ABSTRACT

Bimetallic platinum-palladium hydrocracking catalysts are disclosed. The bimetallic catalyst generally comprises a base material comprising an alumina, an amorphous silica-alumina, and a Y zeolite, and a bimetallic platinum-palladium modifier metal composition dispersed on and/or impregnated within the base material. The catalyst is useful as a hydrocracking catalyst for hydrocarbon feedstocks, including as a second stage catalyst to produce fuels, and more particularly to produce higher yields of jet fuels.

### CROSS-REFERENCE TO RELATED APPLICATIONS

This application claims the benefit of priority to U.S. Provisional Patent Appl. Ser. No. 63/165,016, filed on Mar. 23, 2021, entitled “PLATINUM-PALLADIUM BIMETALLIC HYDROCRACKING CATALYST”, the disclosure of which is herein incorporated by reference in its entirety.

### FIELD OF THE INVENTION

The invention concerns bimetallic platinum-palladium hydrocracking catalysts. The invention can be used for hydrocracking hydrocarbon feedstocks to produce fuels, and is notably useful for second stage hydrocracking to produce increased jet fuel yield.

### BACKGROUND OF THE INVENTION

Catalytic hydroprocessing refers to petroleum refining processes in which a carbonaceous feedstock is brought into contact with hydrogen and a catalyst, at a higher temperature and pressure, for the purpose of removing undesirable impurities and/or converting the feedstock to an improved product. Examples of hydroprocessing processes include hydrotreating, hydrodemetallization, hydrocracking and hydroisomerization processes.

A hydroprocessing catalyst typically consists of one or more metals deposited on a support or carrier consisting of an amorphous oxide and/or a crystalline microporous material (e.g., a zeolite). The selection of the support and metals depends upon the particular hydroprocessing process for which the catalyst is employed.

It is well known that zeolites play a key role in hydrocracking and hydroisomerization reactions, and the pore structures of zeolites largely dictate their catalytic selectivity. The two processes achieve different results and different catalysts are required.

Hydrocracking refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins. Hydroisomerization refers to a process in which normal paraffins are isomerized to their more branched counterparts in the presence of hydrogen over a catalyst.

Hydrocracking is particularly useful to produce distillate fuels. Creating new catalysts and combinations to improve the conversion and yield of desired distillate products by hydrocracking processes would be of great use to the industry. Despite the progress made in preparing hydrocracking catalysts, however, a continuing need exists for improved catalysts and processes to prepare and use such catalysts, particularly those leading to improvements in hydrocracking applications.

### SUMMARY OF THE INVENTION

This invention generally provides a hydrocracking catalyst comprising a base material of an alumina, an amorphous silica-alumina (ASA), and a Y zeolite; and a bimetallic platinum-palladium modifier metal composition dispersed on and/or impregnated within the base material. A hydroprocessing catalyst according to the invention may be formed from a base material comprising the alumina, ASA and the Y zeolite by impregnating, depositing thereupon, or otherwise combining catalytically active platinum and palladium metals with the base material. While not limited thereto, the catalyst is particularly useful for second stage hydrocracking of hydrocarbonaceous feedstocks to produce fuels products having increased jet yield. One of the goals of the invention is to provide improvements in catalyst performance that generally also provide lower capital and operating costs for hydroprocessing applications. It is also desirable to provide commercial flexibility in using alternative hydrocracking catalysts for distillate fuels production.

The present invention is also directed to a process of making the catalyst, comprising combining an alumina, an amorphous silica-alumina (ASA), and a Y zeolite to form a blended extrudable base material composition; extruding the composition to form an extruded base material; contacting the extruded base material with an impregnation solution comprising an optionally pH buffered aqueous solution comprising platinum and palladium, and/or platinum and/or palladium precursor compounds thereto; drying the impregnated base material at a temperature sufficient to form dried extruded base material; and calcining the dried base material.

The invention further relates to a process for hydrocracking a hydrocarbonaceous feedstock in which the hydrocracking catalyst is contacted with a hydrocarbonaceous feedstock under hydrocracking conditions to produce one or more desired products. Advantageously, the hydrocracking process may be used to form products comprising distillate fuels, particularly middle distillate fuels such as jet fuel.

### BRIEF DESCRIPTION OF THE DRAWINGS

The scope of the invention is not limited by any representative figures accompanying this disclosure and is to be understood to be defined by the claims of the application.

FIG. 1 provides a schematic diagram of the bench scale reactor system used as described in the examples.

### DETAILED DESCRIPTION

Although illustrative embodiments of one or more aspects are provided herein, the disclosed processes, and compositions formed therefrom, may be implemented using any number of techniques. The disclosure is not limited to the illustrative or specific embodiments, drawings, and techniques illustrated herein, including any exemplary designs and embodiments illustrated and described herein, and may be modified within the scope of the appended claims along with their full scope of equivalents.

Unless otherwise indicated, the following terms, terminology, and definitions are applicable to this disclosure. If a term is used in this disclosure but is not specifically defined herein, the definition from the IUPAC Compendium of Chemical Terminology, 2nd ed (1997), may be applied, provided that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein is to be understood to apply.

“Periodic Table” refers to the version of IUPAC Periodic Table of the Elements dated Jun. 22, 2007, and the numbering scheme for the Periodic Table Groups is as described in Chemical and Engineering News, 63(5), 27 (1985).

“Hydrocarbonaceous”, “hydrocarbon” and similar terms refer to a compound containing only carbon and hydrogen atoms. Other identifiers may be used to indicate the presence of particular groups, if any, in the hydrocarbon (e.g., halogenated hydrocarbon indicates the presence of one or more halogen atoms replacing an equivalent number of hydrogen atoms in the hydrocarbon).

“Hydroprocessing” or “hydroconversion” refers to a process in which a carbonaceous feedstock is brought into contact with hydrogen and a catalyst, at a higher temperature and pressure, for the purpose of removing undesirable impurities and/or converting the feedstock to a desired product. Such processes include, but not limited to, methanation, water gas shift reactions, hydrogenation, hydrotreating, hydrodesulphurization, hydrodenitrogenation, hydrodemetallation, hydrodearomatization, hydroisomerization, hydrodewaxing and hydrocracking including selective hydrocracking. Depending on the type of hydroprocessing and the reaction conditions, the products of hydroprocessing can show improved physical properties such as improved viscosities, viscosity indices, saturates content, low temperature properties, volatilities and depolarization.

“Hydrocracking” refers to a process in which hydrogenation and dehydrogenation accompanies the cracking/fragmentation of hydrocarbons, e.g., converting heavier hydrocarbons into lighter hydrocarbons, or converting aromatics and/or cycloparaffins (naphthenes) into non-cyclic branched paraffins.

“Hydrotreating” refers to a process that converts sulfur- and/or nitrogen-containing hydrocarbon feeds into hydrocarbon products with reduced sulfur and/or nitrogen content, typically in conjunction with a hydrocracking function, and which generates hydrogen sulfide and/or ammonia (respectively) as byproducts.

The term “support”, particularly as used in the term “catalyst support”, refers to conventional materials that are typically a solid with a high surface area, to which catalyst materials are affixed. Support materials may be inert or participate in the catalytic reactions, and may be porous or non-porous. Typical catalyst supports include various kinds of carbon, alumina, silica, and silica-alumina, e.g., amorphous silica aluminates, zeolites, alumina-boria, silica-alumina-magnesia, silica-alumina-titania and materials obtained by adding other zeolites and other complex oxides thereto.

“Molecular sieve” refers to a material having uniform pores of molecular dimensions within a framework structure, such that only certain molecules, depending on the type of molecular sieve, have access to the pore structure of the molecular sieve, while other molecules are excluded, e.g., due to molecular size and/or reactivity. Zeolites, crystalline aluminophosphates and crystalline silicoaluminophosphates are representative examples of molecular sieves.

“Middle distillates” include jet fuel, diesel fuel, and kerosene, typically with representative cut points as shown below:

| | Typical Cut Points, ° F. (° C.) for |
|---|---|
| Products | North American Market |
| Light Naphtha | C₅-180 (C₅-82) |
| Heavy Naphtha | 180-300 (82-149) |
| Jet | 300-380 (149-−193) |
| Kerosene | 380-530 (193-277) |
| Diesel | 530-700 (277-371) |

The foregoing ranges are, in some cases, more particularly defined by standard grade specifications. For example, as specified by ASTM D86, Jet A-1 fuel generally has an initial boiling point (IBP) of 145° C. (293° F.) and a final boiling point (FBP) of 256° C. (493° F.).

SiO₂/Al₂O₃ ratio (SAR) is determined by inductively coupled plasma (ICP) elemental analysis. A SAR of infinity means there is no aluminum in the zeolite, i.e., the mole ratio of silica to alumina is infinity.

“Amorphous silica aluminate”, “amorphous silica alumina” and “ASA” refer to a synthetic material having some of the alumina present in tetrahedral coordination as shown by nuclear magnetic resonance imaging. ASA can be used as a catalyst or catalyst support. Amorphous silica alumina contains sites which are termed Brönsted acid (or protic) sites, with an ionizable hydrogen atom, and Lewis acid (aprotic) electron accepting sites. Different types of acidic sites can be distinguished by the ways in which particular chemical species attach (e.g., pyridine).

Surface area: determined by nitrogen adsorption at its boiling temperature. BET surface area is calculated by the 5-point method at P/P₀=0.050, 0.088, 0.125, 0.163, and 0.200. Samples are first pre-treated at 400° C. for 6 hours in the presence of flowing, dry nitrogen.

Pore/micropore volume: determined by nitrogen adsorption at its boiling temperature. Micropore volume is calculated by the t-plot method at P/P₀=0.050, 0.088, 0.125, 0.163, and 0.200. Samples are first pre-treated at 400° C. for 6 hours in the presence of flowing, dry nitrogen.

Pore diameter: determined by nitrogen adsorption at its boiling temperature. Mesopore pore diameter is calculated from nitrogen isotherms by the BJH method described in E. P. Barrett, L. G. Joyner and P. P. Halenda, “The determination of pore volume and area distributions in porous substances. I. Computations from nitrogen isotherms.” J. Am. Chem. Soc. 73, 373-380, 1951. Samples are first pre-treated at 400° C. for 6 hours in the presence of flowing, dry nitrogen.

Total pore volume: determined by nitrogen adsorption at its boiling temperature at P/P0=0.990. Samples are first pre-treated at 400° C. for 6 hours in the presence of flowing, dry nitrogen.

Particle density: obtained by applying the formula D=M/V. M is the weight and V is the volume of the catalyst sample. The volume is determined by measuring volume displacement by submersing the sample into mercury under 28 mm Hg vacuum.

Unit cell size: determined by X-ray powder diffraction.

Particle size distribution of silica domains: samples were mounted in a resin and cross-sections were cut, polished and coated to ensure conductivity. Backscattered electron images and elemental maps of the samples were obtained at 20 kV, 20 nA using a JEOL JXA 8230 electron probe microanalyzer (EPMA). The elemental maps were subjected to image segmentation using ZEISS ZEN Intellesis software. After segmentation, the maximum Feret diameter was determined as a structural parameter and used to generate histograms that represent the particle size distribution of silica domains.

In this disclosure, while compositions and methods or processes are often described in terms of “comprising” various components or steps, the compositions and methods may also “consist essentially of” or “consist of” the various components or steps, unless stated otherwise.

The terms “a”, “an”, and “the” are intended to include plural alternatives, e.g., at least one. For instance, the disclosure of “a transition metal” or “an alkali metal” is meant to encompass one, or mixtures or combinations of more than one, transition metal or alkali metal, unless otherwise specified.

All numerical values within the detailed description and the claims herein are modified by “about” or “approximately” the indicated value, and take into account experimental error and variations that would be expected by a person having ordinary skill in the art.

The present invention provides a hydrocracking catalyst that is suitable for use in second stage hydrocracking of hydrocarbonaceous feedstocks to produce middle distillates, including fuels products having increased jet yield. The catalyst comprises a base material comprising an alumina, an amorphous silica-alumina, and a Y zeolite. A catalytically active palladium and platinum modifier metal composition is dispersed on and/or impregnated within the base material to form the active hydrocracking catalyst.

In general, the hydrocracking catalyst may comprise each of the alumina, amorphous silica alumina and the Y zeolite in any amount. In typical cases, the base material may broadly comprise about 10-30 wt. %, or 15-30 wt. %, or 20-30 wt. %, or 10-25 wt. %, or 10-20 wt. % of the alumina; about 10-30 wt. %, or 15-30 wt. %, or 20-30 wt. %, or 10-25 wt. %, or 10-20 wt. % of the amorphous silica alumina (ASA); and about 40-70 wt. %, or 50-70 wt. %, or 60-70 wt. %, or 40-60 wt. %, or 40-50 wt. %, or 50-60 wt. % Y zeolite.

The hydrocracking catalyst according to the invention comprises the base material in the range of about 40 to less than 100 wt. %, or 40 99 wt. %, or 50-99 wt. %, or 60-99 wt. %, or 70-99 wt. %. The noble Pd and Pt metal content is generally in the range of about 0.1 to 5 wt. %, or 0.1-4 wt. %, or 0.1-3 wt. % or 0.1-2 wt. %. In some cases, the bimetallic Pd and Pt metal content may be about 0.1 to 1.0 wt. % or 0.1 to 0.9 wt. % or 0.1 to 0.8 wt. % or 0.1 to 0.7 wt. % or 0.1 to 0.6 wt. % or 0.2 to 1.0 wt. % or 0.2 to 0.9 wt. % or 0.2 to 0.8 wt. % or 0.2 to 0.7 wt. % or 0.2 to 0.6 wt. % or 0.3 to 1.0 wt. % or 0.3 to 0.9 wt. % or 0.3 to 0.8 wt. % or 0.3 to 0.7 wt. % or 0.3 to 0.6 wt. % or 0.4 to 1.0 wt. % or 0.4 to 0.9 wt. % or 0.4 to 0.8 wt. % or 0.4 to 0.7 wt. % or 0.4 to 0.6 wt. % total metal on a dry weight basis of the catalyst. In some cases, a base metal may be included, with amounts in the range of about 0-40 wt. %, or 5-40 wt. %, or 5-30 wt. %, or 10-40 wt. %, or 10-30 wt. %, or 10-20 wt. %, or 20-40 wt. %, or 20-30 wt. %; wherein the total base metal content is optionally in the range of 0-40 wt. %, or 5-40 wt. %, or 5-30 wt. %, or 10-40 wt. %, or 10-30 wt. %, or 10-20 wt. %, or 20-40 wt. % or 20-30 wt. %. A promoter may also be included, with amounts in the range of about 0-30 wt. %, or 0-20 wt. %, or 0-10 wt. %, or 5-30 wt. %, or 5-20 wt. %, or 10 30 wt. %, or 10-20 wt. %. Suitable noble metals include, e.g., bimetallic Pt and Pd compositions, while suitable base metals include Ni, Mo, Co, and W. Combinations of noble, base, and noble and base metals may also be employed. Suitable promoters are described in U.S. Pat. No. 8,637,419 B2 to Zhan. The presence of base metal(s) and/or promoter(s) is not required, however, and, in some cases, the hydrocracking catalyst excludes any base metal(s) and/or any promoter(s).

Suitable bimetallic Pd and Pt active metal hydrocracking catalysts may, in some cases, comprise molar Pd:Pt ratios in the range of 10:90 to 90:10 or 20:80 to 80:20 or 30:70 to 70:30 or 40:60 to 60:40 or 40:60 to 90:10 or 40:60 to 80:20.

In general, the support materials forming the base material include alumina and an amorphous silica alumina. Suitable aluminas include one or more of γ-alumina, η-alumina, θ-alumina, δ-alumina, χ-alumina, and mixtures thereof. The amorphous silica alumina (ASA) may generally be any ASA that is suitable for forming the hydrocracking catalyst, e.g., an ASA having a mean mesopore diameter between about 70 to 130 Å. Suitable ASA's may also typically have SiO₂ contents in the range of about 5 to 70 wt. % (based on the bulk dry weight of the carrier as determined by ICP elemental analysis), a BET surface area of between 300 and 550 m²/g and a total pore volume of between about 0.95 and 1.55 mL/g. In some cases, the ASA may contain SiO₂ in the range of about 5 to 70 wt. % (based on the bulk dry weight of the carrier as determined by ICP elemental analysis) and have a BET surface area of between 300 and 550 m²/g, a total pore volume of between about 0.95 and 1.55 mL/g, and a mean mesopore diameter between about 70 to 130 Å.

The ASA support may also be a highly homogeneous amorphous silica-alumina material having a surface to bulk silica to alumina ratio (S/B ratio) of 0.7 to 1.3, and a crystalline alumina phase present in an amount no more than about 10 wt. %.

$$S / B ratio = \frac{( Si / Al atomic ratio of the surface measured by X P S )}{( Si / Al atomic ratio of the bulk measured by elemental analysis )}$$

To determine the S/B ratio, the Si/Al atomic ratio of the silica-alumina surface is measured using x-ray photoelectron spectroscopy (XPS). XPS is also known as electron spectroscopy for chemical analysis (ESCA). Since the penetration depth of XPS is less than 50 Å, the Si/Al atomic ratio measured by XPS is for the surface chemical composition.

Use of XPS for silica-alumina characterization was published by W. Daneiell et al. in Applied Catalysis A, 196, 247-260, 2000. The XPS technique is, therefore, effective in measuring the chemical composition of the outer layer of catalytic particle surface. Other surface measurement techniques, such as Auger electron spectroscopy (AES) and Secondary-ion mass spectroscopy (SIMS), could also be used for measurement of the surface composition.

The bulk Si/Al ratio of a composition is determined from ICP elemental analysis. By comparing the surface Si/Al ratio to the bulk Si/Al ratio, the S/B ratio and the homogeneity of silica-alumina are determined. How the SB ratio defines the homogeneity of a particle in which an SIB ratio of 1.0 means the material is completely homogeneous throughout the particles. An SIB ratio of less than 1.0 means the particle surface is enriched with aluminum (or depleted with silicon), and aluminum is predominantly located on the external surface of the particles. The S/B ratio of more than 1.0 means the particle surface is enriched with silicon (or depleted with aluminum), and aluminum is predominantly located on the internal area of the particles.

Suitable amorphous silica aluminas (ASA) may be commercially available materials from Sasol, JGC Catalysts and Chemicals, and PIDC (Pacific Industrial Development Corporation). Suitable ASA's are also known in the patent literature, including, e.g., in U.S. Pat. No. 10,183,282. One such family of ASA's include, e.g., SIRAL® ASA's from Sasol (Table 1).

TABLE 1

| Typical Properties | SIRAL 1 | SIRAL 5 | SIRAL 10 | SIRAL 20 | SIRAL 30 | SIRAL 40 |
|---|---|---|---|---|---|---|
| Al₂O₃ + SiO₂ (%) | 75 | 75 | 75 | 75 | 75 | 75 |
| Loss on Ignition, LOI (%) | 25 | 25 | 25 | 25 | 25 | 25 |
| Al₂O₃:SiO₂ % | 99:1 | 95:5 | 90:10 | 80:20 | 70:30 | 60:40 |
| C (%) | 0.2 | 0.2 | 0.2 | 0.2 | 0.2 | 0.2 |
| Fe₂O₃ (%) | 0.02 | 0.02 | 0.02 | 0.02 | 0.02 | 0.02 |
| Na₂O (%) | 0.005 | 0.005 | 0.005 | 0.005 | 0.005 | 0.005 |
| Loose bulk density (g/l) | 600-800 | 450-650 | 400-600 | 300-500 | 250-450 | 250-450 |
| Particle size, d50 (μm) | 50 | 50 | 50 | 50 | 50 | 50 |
| Surface area, BET* (m²/g) | 280 | 370 | 400 | 420 | 470 | 500 |
| Pore volume* (ml/g) | 0.50 | 0.70 | 0.75 | 0.75 | 0.80 | 0.90 |

*After activation at 550° C. for 3 hours

Aluminas suitable for use in the invention are also commercially available and known in the patent literature, including, e.g., in U.S. Pat. No. 10,183,282. One such family of alumina's include, e.g., CATAPAL® alumina's from Sasol (Table 2). PURAL® alumina's from Sasol may also be suitable.

TABLE 2

| Typical Properties | CATAPAL B | CATAPAL C1 | CATAPAL D | CATAPAL 200 |
|---|---|---|---|---|
| Al₂O₃ (wt. %) | 72 | 72 | 72 | 72 |
| Na₂O (wt. %) | 0.002 | 0.002 | 0.002 | 0.002 |
| Loose bulk density (g/l) | 670-750 | 670-750 | 700-800 | 500-700 |
| Compacted bulk density (g/l) | 800-1100 | 800-1100 | 800-1100 | 700-800 |
| Particle size, d50 (μm) | 60 | 60 | 40 | 40 |
| Surface area, BET* (m²/g) | 250 | 230 | 220 | 100 |
| Pore volume* (ml/g) | 0.50 | 0.50 | 0.55 | 0.70 |
| Crystal size (nm) | 4.5 | 5.5 | 7.0 | 40 |

*After activation at 550° C. for 3 hours

The Y zeolite component of the base material may generally be any Y zeolite suitable for use in a hydrocracking catalyst. Y zeolites are synthetic faujasite (FAU) zeolites having a SAR of 3 or higher. Y zeolite can be ultra-stabilized (i.e., “Zeolite USY” refers to ultra-stabilized Y zeolite, referred to as “USY” zeolite) by one or more of hydrothermal stabilization, dealumination, and isomorphous substitution. Zeolite USY can be any FAU-type zeolite with a higher framework silicon content than a starting (as synthesized) Na-Y zeolite precursor. Such suitable Y zeolites are commercially available from, e.g., Zeolyst, Tosoh, and JGC.

In some cases, the Y zeolite may have a unit cell size of about 24.15 Å to about 24.45 Å, or, in some cases, a unit cell size of about 24.15 Å to about 24.35 Å. The Y zeolite may be a low-acidity, highly dealuminated ultrastable Y zeolite (USY) having an Alpha value of less than 5 and a Brönsted acidity of from 1 to 40 μmole/g. While not limited thereto, the Y zeolite may have the following properties: alpha values of about 0.01 to 5; constrained index (CI) of about 0.05 to 5%; a Brönsted acidity of from about 1 to 40 μmole/g; a silica to alumina (SAR) ratio of from about 80 to 150; a surface area of from about 650 to 750 m²/g; a micropore volume of from about 0.25 to 0.30 mL/g; a total pore volume of from about 0.51 to 0.55 mL/g; and a unit cell size of from about 24.15 Å to about 24.35 Å. In addition to or instead of the foregoing properties, the Y zeolite may also have a SAR of at least about 10; a micropore volume of from about 0.15 to 0.27 mL/g; a BET surface area of from about 700 to 825 m²/g; and a unit cell size of from about 24.15 Å to about 24.45 Å.

The invention further provides a process of making the hydrocracking catalyst, the process comprising combining an alumina, an amorphous silica-alumina (ASA), and a Y zeolite to form a blended extrudable base material composition; extruding the composition to form an extruded base material; contacting the extruded base material with an impregnation solution comprising an optionally pH buffered aqueous solution comprising platinum and palladium, and/or platinum and/or palladium precursor compounds thereto; drying the impregnated base material at a temperature sufficient to form dried extruded base material; and calcining the dried base material.

Impregnation and/or deposition of the catalytically active metals (Pt and Pd) may be achieved by contacting at least the catalyst base material with an impregnation solution comprising the active metals and/or precursor compounds thereof. The impregnation solution contains at least one metal salt such as a metal nitrate or metal carbonate, solvent and typically has a pH between 4 and 11, inclusive (i.e., 4≤pH≤11) In particular, the hydrocracking catalyst is prepared by: mixing/blending and forming an extrudable mass containing the catalyst base material comprised of alumina, an amorphous silica alumina (ASA), and Y zeolite; extruding the mass to form a shaped extrudate; calcining the mass to form a calcined extrudate; contacting the shaped extrudate with an impregnation solution containing Pt and Pd compounds and solvent, and, optionally, having a pH between about 4 and 11, inclusive; drying the impregnated extrudate at a temperature sufficient to remove the impregnation solution solvent to form a dried impregnated extrudate.

The shaped hydrocracking catalyst may also be prepared by: mixing/blending and forming an extrudable mass containing the catalyst base material comprised of alumina, an amorphous silica alumina (ASA), and a USY zeolite; extruding the mass to form a shaped extrudate; calcining the mass to form a calcined extrudate; contacting the shaped extrudate with an impregnation solution containing Pt and Pd compounds and solvent, optionally, wherein the impregnation solution has a pH between about 4 and 11, inclusive; and drying the impregnated extrudate at a temperature sufficient to remove the impregnation solution solvent and form a dried impregnated extrudate.

A suitable impregnation solution comprises an aqueous solution of Pt(NH₃)₄(NO₃)₂ and Pd(NH₃)₄(NO₃)₂, and/or Pd and/or Pt precursor compounds thereto, and, optionally, buffered to a pH in the range of about 4-11 or 6-11 or 8-11 or 9-11. Typically, the impregnated base material is dried for about 1-24 hrs or 1-8 hrs at a temperature in the range of about 100-160° C. and then calcined for about 0.2-2 or 0.2-1.0 hrs at a temperature in the range of about 300 to 510° C.

Further details concerning suitable process conditions for making the catalyst, including, solvents, impregnation, drying, and calcination conditions may be found in the patent literature, e.g., U.S. Pat. Nos. 9,187,702, and 10,183,282.

The invention further relates to a process for hydrocracking a hydrocarbonaceous feedstock in which the hydrocracking catalyst is contacted with a hydrocarbonaceous feedstock under hydrocracking conditions to produce one or more desired products. Advantageously, the hydrocracking process may be used to form products comprising distillate fuels, particularly middle distillate fuels such as jet fuel. Among the benefits of the hydrocracking process using the catalyst of the invention is the ability to provide a higher jet yield than a corresponding process using a non-bimetallic catalyst when both catalysts are separately contacted with the same hydrocarbonaceous feed under the same process conditions, wherein the non-bimetallic catalyst differs only in that it is not bimetallic and includes only platinum as the modifier metal. In addition, the hydrocracking process has a greater sulfur tolerance than a corresponding process using a non-bimetallic catalyst when both catalysts are separately contacted with the same hydrocarbonaceous feed under the same process conditions, wherein the non-bimetallic catalyst differs only in that it is not bimetallic and includes only platinum as the modifier metal.

The hydrocracking catalyst is primarily intended for use in a second stage hydrocracker process. By comparison, the feed to a single stage hydrocracker typically has greater concentrations of nitrogen and sulfur, often as ammonia and hydrogen sulfide. Hydrocracking catalysts must be able to endure such dirty feeds as the presence of higher nitrogen and sulfur levels can adversely impact reaction rates, thereby potentially leading to adverse effects on product selectivity and catalyst activity. The hydrocracking process of the invention is therefore primarily intended to comprise contacting the catalyst with a feedstock that has low N and S levels so that an effluent comprising middle distillates is produced from the process. The catalyst may be employed in one or more fixed beds in a hydrocracking unit, with recycle or without recycle (once through). Multiple stage units operated in parallel may also be used.

While not limited thereto, suitable hydrocarbonaceous feedstocks comprise visbroken gas oil (VGB), heavy coker gas oil, gas oil derived from residue hydrocracking or residue desulfurization, vacuum gas oil, thermally cracked oil, deasphalted oil, Fischer-Tropsch derived feedstock, FCC cycle oil, heavy coal-derived distillate, coal gasification byproduct tar, heavy shale-derived oil, organic waste biomass oil, pyrolysis oil, or a mixture thereof. The hydrocracking process is particularly useful as a second stage hydrocracking catalyst, in particular, wherein the sulfur and nitrogen contents of the second stage feed are relatively low. For example, in some cases, the S and N content of the hydrocarbonaceous feedstock to a second stage hydrocracker comprising the catalyst may be individually or both less than about 200 ppm, or 150 ppm, or 100 ppm, or 50 ppm, or 20 ppm or 10 ppm or 5 ppm or 2 ppm or 1 ppm.

Suitable hydrocracking conditions generally include any combination of temperature, pressure, liquid hourly space velocity and/or other process conditions that are typically used in hydrocracking processes, more particularly in second stage hydrocracking. For example, suitable conditions may include a temperature in the range of from 175° C. to 485° C., molar ratios of hydrogen to hydrocarbon charge from 1 to 100, a pressure in the range of from 0.5 to 350 bar, and a liquid hourly space velocity (LHSV) in the range of from 0.1 to 30. Further details concerning suitable second stage hydrocracking process conditions may be found in the patent literature, e.g., U.S. Pat. No. 10,183,282.

The hydrocracking catalyst provides certain improvements in a second stage hydrocracking process, including providing a higher jet yield than a corresponding non-bimetallic catalyst when both catalysts are separately contacted with the same hydrocarbonaceous feed under the same process conditions, wherein the non-bimetallic catalyst differs only in that it is not bimetallic and includes only platinum as the modifier metal. In addition, the catalyst provides greater sulfur tolerance than a corresponding non-bimetallic catalyst when both catalysts are separately contacted with the same hydrocarbonaceous feed under the same process conditions, wherein the non-bimetallic catalyst differs only in that it is not bimetallic and includes only platinum as the modifier metal. Results demonstrating the foregoing beneficial effects are provided in the following examples.

### EXAMPLES

### Catalyst and Comparative Catalyst Preparation

Commercially prepared pellets of the catalyst base material were used, in all cases, as the base (support) material for metal impregnation using aqueous Pd and Pt precursors. The base material was a blended and extruded solid powder mix containing USY zeolite (Zeolyst), alumina binder (Catapal®, Sasol), and amorphous silica alumina (Siral®, Sasol) in proportions of 56.4 wt. %, 22.6 wt. %, and 21.0 wt. % (dry basis), respectively. The commercially produced base material pellets were heated in a rotary calciner for approximately 30 minutes at 1100° F. under 0.04 cf/g/hr of dry air flow subsequent to their extrusion.

The extruded, sized, and calcined quadrilobe base pellets were impregnated with aqueous Pd(NH₃)₄(NO₃)₂ and/or Pt(NH₃)₄(NO₃)₂ and then calcined a second time to form the finished noble metal catalysts. The liquid solution volumes used for the impregnations were equivalent to 102% of the measured water pore volume (WPV) of the pellets, i.e., the incipient wetness volume. Such liquid solutions contained Pd(NH₃)₄(NO₃)₂ and/or Pt(NH₃)₄(NO₃)₂ in amounts required to reach the desired metal loadings (0.5 wt. % Pd, base case; or 0.19 wt. % Pt and 0.31 wt. % Pd, Pd-rich; or 0.32 wt. % Pt and 0.18 wt. % Pd, Pt-rich) in the finished catalysts (dry basis) assuming complete incorporation of the added metal and full removal of nitrogenous compounds by the post-impregnation calcination. The impregnation solutions were buffered at pH 9.2-9.4 by aqueous HNO₃ and NH₄OH (to give an effective NH₄NO₃ concentration of 0.15 M). Samples were prepared via impregnation of the catalyst base in 100 g batches (dry basis).

The aqueous metal solutions were loaded into the catalyst base pellets by vacuum impregnation. The catalyst base pellets (100 g) were first placed in a 3-neck round bottom flask (1000 mL) connected via plastic tubing to a sealed container of the impregnation liquid. One end of the tubing was submerged within the impregnation liquid, and the other was positioned directly over the bed of base pellets, causing the liquid to spray onto the pellet bed for a period of 1 min. upon evacuation of the flask to 230 torr. The flask was then shaken, re-pressurized with ambient air to atmospheric pressure, re-sealed, and allowed to sit at ambient temperature for 12 hr. The wet pellets were then removed from the flask and placed on a screen tray (to form a 1.0″ thick layer) and heated in a convection oven at 300° F. for 1 hr. Lastly, the catalysts were transferred in their screen trays to a muffle furnace and calcined with 0.04 cm³/g/hr of dry air flow upward through the screen and pellet bed. The monometallic Pd sample was calcined by heating from ambient temperature to 950° F. (at 14.6° F./min) and holding for 1 hr. The Pd-rich and Pt-rich bimetallic samples were transferred to a muffle furnace pre-heated to 300° F., and then shock calcined by heating to 725° F. or 752° F., respectively, in a period of approx. 10-15 minutes and held for 30 minutes.

### Catalysts A and B and Comparative Catalyst C

Inventive catalysts A and B and comparative catalyst C (base case) were prepared in accordance with the foregoing preparation procedures. Catalyst A contained Pd and Pt in a Pd:Pt molar ratio of 75:25; catalyst B contained Pd and Pt in a Pd:Pt molar ratio of 50:50; and catalyst C (base case) contained Pd and Pt in a Pd:Pt molar ratio of 100:0. Table 3 presents characterization property information for each of catalysts A, B, and C.

TABLE 3

| | | | Catalyst C |
|---|---|---|---|
| Property | Catalyst A | Catalyst B | (base case) |
| Total Pd, Pt Metal (wt. %) | 0.40 | 0.43 | 0.43 |
| Pd:Pt Mass Ratio | 62:38 | 34:66 | 100:0 |
| Pd:Pt Mole Ratio | 75:25 | 48:52 | 100:0 |
| Total Pd, Pt Metal (μmolₘₑₜₐₗ/g) | 31 | 28 | 41 |
| Calcination Temperature (° C.) | 385 | 400 | 510 |
| Volatiles (%) | 7.3 | 9.1 | 3.4 |
| ASA Particle Density (g/cm³) | 0.912 | N/A | 0.915 |
| N₂ Surface Area (m²/g) | 520 | N/A | 534 |
| Metal + Alkali impurity (ppm) | <878 | <1020 | <917 |

### Hydrocracking Performance of Catalysts A, B and Comparative Catalyst C

Samples of catalyst C (containing Pd; “base case” comparative catalyst) and catalyst A and B (containing Pd and Pt) prepared as described herein were assessed for their performance as hydrocracking (HCR) catalysts in bench-scale unit (BSU) tests intending to mimic industrial conditions. HCR testing was conducted on catalyst pellets (approx. 3.0 g dry weight, 6.0 cm³ vibrated volume) packed within a ⅜″ OD steel downflow fixed bed reactor. Alundum granules sieved to 100 mesh in size were distributed by vibration throughout the interstitial regions between the catalyst pellets to prevent channeling of the liquid hydrocarbon feed. The pellets were further stacked between ¾″ layers of glass wool (both above and below the pellet bed) and 100 mesh alundum (11.8″ in height above and below the pellet bed) to center the catalyst charge within the middle of a three-zone resistively heated tube furnace.

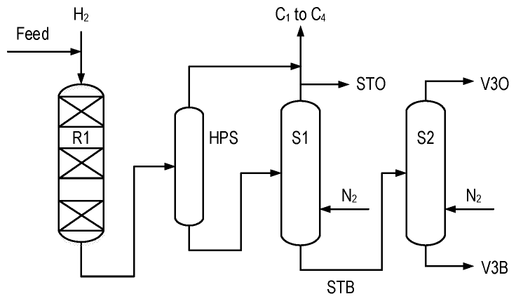

Hydrogen and liquid hydrocarbon feed flowrates into the reactor (R1, FIG. 1) were metered using mass flow controllers or a liquid reciprocating piston pump. All unit lines and the liquid feed were heated to 120-160° F. to prevent the development of occlusions by reactant or product compounds. The prevailing reactor pressure was regulated by high pressure control valves installed downstream of the reactor. Condensed liquid products were collected by first passing the reactor effluent through a high-pressure liquid-gas separator (HPS) heated to 150° F. and regulated by a liquid level control system. The separated liquid fraction was further fractionated in a stripper column (S1) heated to 280-330° F. with 0.001 ft³/min nitrogen flow regulated by a mass flow controller. One liquid fraction was collected by condensing the stripper overhead (STO) with DI water at 32° F., and a second fraction was gathered by collecting the heavier bottoms product (STB) from the stripper column. For brief periods during the testing, the STB stream was further fractionated in a second stripper (S2) to form stripper 2 overhead (V3O) and stripper 2 bottoms (V3B) to conduct analytical testing on three separate liquid fractions. Each liquid fraction was separately analyzed by gas chromatography to speciate the whole liquid product (WLP) based on carbon number and to generate its simulated true boiling point distribution. Nitrogen was fed into each of the strippers (S1 and S2) with light gases (C1 to C4) withdrawn from all the strippers. Gaseous fractions generated in the high-pressure separator and stripper 1 were combined and analyzed by gas chromatography to speciate light fractions in the reactor effluent. Product liquid fractions were collected for 24 h intervals prior to chromatographic analysis. A simplified flow diagram of the BSU process is shown in FIG. 1, in which hydrocarbon feed and hydrogen are fed to reactor R1 with the reactor bottoms passed for separation to high pressure separator HPS. Columns S1 and S2 further provide overhead product STO and V3O and bottoms product STB and V3B. Nitrogen is shown as added to S1 and S2 and C1 to C4 light ends are withdrawn from S1.

The hydrocracking performance of catalysts A, B, and comparative catalyst C comprising the base materials was investigated using a typical hydrocracker feedstock. Physical properties of the petroleum feedstock used to evaluate the hydrocracking catalyst performance for catalysts prepared using the hydroprocessing catalyst base materials of the disclosure are provided in Table 4. In each test, the catalyst was contacted with the feedstock under the following process conditions: 1660 psig total pressure (1552 psia H₂ partial pressure at the reactor inlet), 5104 SCFB H₂ to oil ratio, 1.6 h⁻¹ LHSV; 30 ml/min stripper N₂ flowrate.

TABLE 4

| Property | Value |
|---|---|
| API Gravity | 35.4 |
| Sulfur, ppm wt. | 5.31 |
| Nitrogen, ppm wt. | <0.3 |
| PCI | 26.3 |
| Analysis of hydrocarbon type | |
| Paraffins, LV % | 35.0 |
| Naphthenes, LV % | 58.5 |
| Aromatics, LV % | 6.5 |
| Sulfur, LV % | 0 |
| Viscosity Index, VI | 110.0 |
| Viscosity @ 100, cSt | 2.44 |
| Viscosity @ 70, cSt | 4.10 |
| Simdist, wt. % - ° F.(° C.) | |
| 0.5/5 | 404/485 (207/252) |
| 10/30 | 524/613 (273/323) |
| 50 | 673 (356) |
| 70/90 | 726/805 (386/429) |
| 95/99.5 | 847/948 (453/509) |

The HCR conversion of the noble metal catalysts was calculated using the simulated true boiling distributions of the STO and STB (or V3O and V3B) products collected downstream of the reactor, together with the speciation analysis conducted on the gaseous fraction of the reactor effluent. The fractional (synthetic) HCR conversion is defined in this work as the proportion of the feed oil with a boiling point above 500° F. that is converted by the catalyst into compounds that boil at a temperature below 500° F. HCR synthetic conversion (X_{HCR}) is calculated as follows:

HCR Fractional Conversion (X_{HCR})=(F_{feed}−F_{product})/F_{feed}

wherein,
F_{feed} is the mass fraction of the feed oil boiling above 500° F.; and
F_{product} is the mass fraction of the product boiling above 500° F. collected during a given interval of time.

Comparative hydrocracking performance results for catalysts, A, B, and comparative catalyst C show that the hydrocracking activity over time for each of the catalysts is essentially the same. The yields (mass basis) of representative distillate ranges were used, including jet (300-500° F.), heavy naphtha (180-300° F.), light naphtha (C₅-180° F.), and gas fractions for catalyst A, B, and C at on-target conditions (approx. 75 wt. % HCR conversion) are shown in Table 5. Identical information expressed in terms of volume yields is shown in Table 6. Mean HCR conversions and reactor temperatures for each catalyst were 76.3±0.4%, 76.0±0.2%, and 75.1±0.1%; and 549° F., 552° F., and 555° F. for catalyst C (base case), and catalysts A and B, respectively.

TABLE 5

| | Hydrocracking Yield (wt. %) | | | |
|---|---|---|---|---|
| | Jet | Heavy Naphtha | Light Naphtha | Gas |
| Catalyst | (300-500° F.) | (180-300° F.) | (C₅-180° F.) | (C₄-) |
| A (Pd rich) | 30.2 | 30.2 | 13.4 | 6.0 |
| B (Pt rich) | 30.9 | 28.0 | 14.0 | 6.2 |
| C (base case) | 28.0 | 30.1 | 15.1 | 7.0 |

TABLE 6

| | Hydrocracking Yield (liq. vol. %) | | |
|---|---|---|---|
| | Unconverted | | |
| | Oil (UCO) | Jet | Naphtha |
| Catalyst | (500+° F.) | (300-500° F.) | (C₅-300° F.) |
| A (Pd rich) | 22.9 | 32.8 | 51.3 |
| B (Pt rich) | 23.8 | 33.6 | 49.1 |
| C (base case) | 22.6 | 30.5 | 53.0 |

The Pd-rich and Pt-rich bimetallic samples (catalysts A and B, respectively) each give higher jet yield (30.2 wt. % and 30.9 wt. %, respectively) and lower gas make (6.0 wt. % and 6.2 wt. %) than the single metal catalyst sample (catalyst C) (28.0 wt. % jet, 7.0 wt. % C4-) at on-target HCR conversion (Table 5). The bimetallic samples also exhibited higher overall liquid volume yield (Pd-rich catalyst A: 107.0%; Pt-rich catalyst B: 106.5%) than catalyst C (106.1%), which can be attributed to the lower C₄-yield of the catalysts A and B. The bimetallic samples therefore generate more favorable product yield structures than the base-case single metal sample, with the Pt-rich sample giving the most desirable product distribution overall owing to its relatively high jet yield. The bimetallic samples also exhibited greater hydrogenation activity than the base case catalyst C despite having significantly lower metal loading (molar basis), especially in the case of Pt-rich catalyst B. In some cases, it is expected that such performance benefits will lead to lower hydrogen consumption and an overall heavier product distribution.

In addition, the comparative selectivity of each catalyst over a wide range of conversions has shown that the bimetallic variants consistently provide higher jet yield (by 2-3%) and lower gas yield (by approx. 1.0%) than the Pd-only base case over a wide range of conversions in addition to the target conversion (75 wt. %; Table 5). As such, bimetallic catalysts A and B provide a clear advantage in the product yield structure relative to the single metal base case. Other product properties of interest, including aromatics content, viscosity, and density, produced using bimetallic catalysts A and B were generally close to products produced using catalyst C.

### Hydrocracking Performance of Catalysts A, B, and Comparative Catalyst C—Sulfur Tolerance

Catalysts, A, B, and comparative catalyst C were exposed to sulfur compounds during the lattermost periods of hydrocracking reaction testing to assess the impact of sulfur contamination on catalyst hydrocracking performance, and to evaluate the relative tolerance of each catalyst to sulfur poisoning. In each case, the reactor temperature was first adjusted to achieve a target hydrocracking conversion of approx. 75% with the hydrocracking feed oil (Table 4), after which the feed was swapped for the same feed oil containing 0.0745 wt. % di-n-butyl sulfide (163 ppm S). The liquid feed flowrate, H₂ flowrate, and LHSV (as previously described) were kept fixed before and after the feed change. The catalyst in each case was then held without further adjustments in the reactor temperature, after which the spiked feed was again swapped back to the non-spiked feed oil. The catalysts were then allowed to reach a new steady-state operation (i.e., minimal changes in HCR conversion over 72 hours), again without additional adjustments in the reactor temperature. An identical procedure was subsequently repeated for each catalyst using hydrocracking feed oil (Table 4) containing 0.0939 wt. % dibenzothiophene (163 ppm S). The same catalyst charge was used, in each instance, for sulfur tolerance testing with di-n-butyl sulfide (first) and then dibenzothiophene (second). HCR conversion and the yields of product boiling fractions were monitored over the course of the testing to compare the relative impact of sulfur poisoning on catalysts, A, B, and comparative catalyst C after similar degrees of exposure. Table 7 shows a comparison of the impact of poisoning by di-n-butyl sulfide (DnBS) or dibenzothiophene (DBT) on the hydrocracking yield structure of each of catalysts A, B, and C. Table 8 shows the relative impact of poisoning by di-n-butyl sulfide (DnBS) or dibenzothiophene (DBT) on the hydrocracking yield structure of each catalyst by comparison to the yield performance for each catalyst without the added sulfur compound being present in the feed.

TABLE 7

| | | Hydrocracking Yield (wt. %) | | | |
|---|---|---|---|---|---|
| Catalyst/ | | | Heavy | Light | |
| Sulfur | Conversion | Jet | Naphtha | Naphtha | Gas |
| Compound^{1,2} | (%) | (300-500° F.) | (180-300° F.) | (C₅-180° F.) | (C₄-) |
| A (Pd rich)/ | 77.6 | 30.3 | 31.3 | 13.4 | 6.4 |
| DnBS¹ | 85.7 | 24.6 | 37.2 | 18.8 | 8.9 |
| | 76.9 | 30.5 | 30.9 | 13.3 | 6.2 |
| A (Pd rich)/ | 76.9 | 30.4 | 30.9 | 13.3 | 6.2 |
| DBT² | 84.8 | 24.9 | 37.0 | 18.4 | 8.5 |
| | 75.4 | 30.5 | 29.6 | 12.7 | 6.5 |
| B (Pt rich)/ | 72.9 | 31.2 | 27.1 | 12.8 | 5.7 |
| DnBS | 78.4 | 26.8 | 32.0 | 16.3 | 7.3 |
| | 71.6 | 31.3 | 26.7 | 12.5 | 5.1 |
| B (Pt rich)/ | 71.6 | 31.0 | 26.5 | 12.5 | 5.6 |
| DBT | 79.0 | 26.5 | 32.4 | 16.3 | 7.8 |
| | 72.3 | 30.4 | 27.5 | 12.8 | 5.7 |
| C (base case)/ | 76.9 | 28.4 | 30.9 | 14.7 | 6.7 |
| DnBS | 85.3 | 20.1 | 38.0 | 21.2 | 10.2 |
| | 78.1 | 27.5 | 31.8 | 15.4 | 7.3 |
| C (base case)/ | 78.1 | 27.5 | 31.8 | 15.4 | 7.3 |
| DBT | 85.1 | 19.7 | 38.3 | 21.3 | 9.9 |
| | 82.6 | 26.2 | 34.6 | 17.6 | 8.0 |

¹di-n-butyl sulfide
²dibenzothiophene

TABLE 8

| | Change in Hydrocracking Yield³ (wt. %) | | | |
|---|---|---|---|---|
| Catalyst/ | Jet | Heavy | Light | |
| Sulfur | (300-500° | Naphtha | Naphtha | Gas |
| Compound^{1,2} | F.) | (180-300° F.) | (C₅-180° F.) | (C₄-) |
| A (Pd rich)/DnBS¹ | −5.7 | 5.8 | 3.4 | 1.5 |
| A (Pd rich)/DBT² | −5.6 | 6.2 | 5.1 | 2.3 |
| B (Pt rich)/DnBS | −4.5 | 4.9 | 5.3 | 2.5 |
| B (Pt rich)/DBT | −4.6 | 5.8 | 3.9 | 2.2 |
| C (base case)/DnBS | −8.3 | 7.1 | 6.5 | 3.4 |
| C (base case)/DBT | −7.8 | 6.5 | 5.9 | 2.6 |

¹di-n-butyl sulfide
²dibenzothiophene
²HCR yield change relative to yield without sulfur compound

From Tables 7 and 8, it is noted that the addition of di-n-butyl sulfide or DBT (FIGS. 16-18) to the feed oil caused, in all cases, a shift in the overall product yield structure from jet (300-500° F.) towards lighter fractions, including heavy naphtha (180-300° F.), light naphtha (C5-180° F., and gas (C4−). The increased selectivity to lighter fractions was accompanied in all instances by an increase in the overall HCR conversion upon sulfur exposure.

The magnitude of the deleterious effects of organosulfur exposure differed significantly for each catalyst system. The Pt-rich catalyst B showed the greatest overall sulfur tolerance, with exposure to di-n-butyl sulfide and DBT causing jet yield to drop by 4.5 wt. % and 4.6 wt. % and gas yield to increase by 1.5 wt. % and 2.2 wt. %, respectively. The sulfur tolerance of Pt-rich catalyst B was closely followed by that of Pd-rich catalyst A, which exhibited decreases in jet of yield of 5.7 wt. % and 5.6 wt. % and an increase of gas yield by 2.5 wt. % and 2.3 wt. % for di-n-butyl sulfide and DBT, respectively, while base case catalyst C showed jet yield decreases of 8.3 wt. % and 7.8 wt. % and gas yield increases of 3.4 wt. % and 2.6 wt. %. The overall impact of sulfur exposure (equivalent in all cases to 100 ppm S in the gas phase) was similar for both sulfur compounds.

The effects of sulfur exposure on catalyst performance further demonstrate substantial reversibility for the hydrocracking performance of the bimetallic catalysts under the experimental conditions. While not intending to be bound by any theoretical considerations, it is noted that the total or near-total reversibility of the sulfur effect is consistent with the gradual desorption of sulfur compounds upon removal of the added sulfur from the feed oil. In this regard as well, bimetallic catalysts A and B, and the Pt-rich catalyst B sample in particular, are considered to have exhibited all-around greater tolerance to sulfur exposure than base case single metal catalyst C.

Additional details concerning the scope of the invention and disclosure may be determined from the appended claims.

The foregoing description of one or more embodiments of the invention is primarily for illustrative purposes, it being recognized that variations might be used which would still incorporate the essence of the invention. Reference should be made to the following claims in determining the scope of the invention.

For the purposes of U.S. patent practice, and in other patent offices where permitted, all patents and publications cited in the foregoing description of the invention are incorporated herein by reference to the extent that any information contained therein is consistent with and/or supplements the foregoing disclosure.

1. A hydrocracking catalyst, useful for second stage hydrocracking of hydrocarbonaceous feedstocks to produce fuels products having increased jet yield, comprising
a base material comprising an alumina, an amorphous silica-alumina, and a Y zeolite; and
a bimetallic platinum-palladium modifier metal composition dispersed on and/or impregnated within the base material.

2. The catalyst of claim 1, wherein the modifier comprises platinum and palladium in a molar Pd:Pt ratio in the range of 10:90 to 90:10 or 20:80 to 80:20 or 30:70 to 70:30 or 40:60 to 60:40 or 40:60 to 90:10 or 40:60 to 80:20.

3. The catalyst of claim 1, wherein the content of the modifier metal composition is in the range of about 0.1 to 1.0 wt. % or 0.1 to 0.9 wt. % or 0.1 to 0.8 wt. % or 0.1 to 0.7 wt. % or 0.1 to 0.6 wt. % or 0.2 to 1.0 wt. % or 0.2 to 0.9 wt. % or 0.2 to 0.8 wt. % or 0.2 to 0.7 wt. % or 0.2 to 0.6 wt. % or 0.3 to 1.0 wt. % or 0.3 to 0.9 wt. % or 0.3 to 0.8 wt. % or 0.3 to 0.7 wt. % or 0.3 to 0.6 wt. % or 0.4 to 1.0 wt. % or 0.4 to 0.9 wt. % or 0.4 to 0.8 wt. % or 0.4 to 0.7 wt. % or 0.4 to 0.6 wt. % total metal on a dry weight basis of the catalyst.

4. The catalyst of claim 1, wherein the base material is formed as a blended and extruded support.

5. The catalyst of claim 1, wherein the catalyst is formed by impregnating the base material with an impregnation solution comprising platinum and palladium compounds, followed by drying of the impregnated base material for a sufficient time and at a suitable temperature, and subsequently calcining the dried impregnated base material.

6. The catalyst of claim 5, wherein the impregnation solution comprises an aqueous solution of Pt(NH₃)₄(NO₃)₂ and Pd(NH₃)₄(NO₃)₂, and/or Pd and/or Pt precursor compounds thereto, and, optionally, buffered to a pH in the range of about 4-11 or 6-11 or 8-11 or 9-11.

7. The catalyst of claim 5, wherein the impregnated base material is dried for about 1-24 hrs or 1-8 hrs at a temperature in the range of about 100-160° C. and then calcined for about 0.2-2 or 0.2-1.0 hrs at a temperature in the range of about 300-510° C.

8. The catalyst of claim 1, wherein the catalyst provides a higher jet yield than a corresponding non-bimetallic catalyst when both catalysts are separately contacted with the same hydrocarbonaceous feed under the same process conditions, wherein the non-bimetallic catalyst differs only in that it is not bimetallic and includes only platinum as the modifier metal.

9. The catalyst of claim 1, wherein the catalyst provides greater sulfur tolerance than a corresponding non-bimetallic catalyst when both catalysts are separately contacted with the same hydrocarbonaceous feed under the same process conditions, wherein the non-bimetallic catalyst differs from the catalyst only in that it is not bimetallic and includes only platinum as the modifier metal.

10. The catalyst of claim 1, wherein the alumina content is in the range of about 10-30 wt. %, the amorphous silica-alumina content is in the range of about 10-30 wt. %, and the Y zeolite content is in the range of about 40-70 wt. %.

11. A process of making the catalyst of claim 1, comprising
combining an alumina, an amorphous silica-alumina (ASA), and a Y zeolite to form a blended extrudable composition;
extruding the composition to form an extruded base material;
contacting the extruded base material with an impregnation solution comprising an aqueous solution of Pt(NH₃)₄(NO₃)₂ and Pd(NH₃)₄(NO₃)₂, and/or Pd and/or Pt precursor compounds thereto, and, optionally, buffered to a pH in the range of about 4-11 or 6-11 or 8-11 or 9-11;
drying the impregnated base material at a temperature sufficient to form dried extruded base material; and
calcining the dried base material.

12. The process of claim 11, wherein the impregnated base material is dried for about 1-24 hrs or 1-8 hours at a temperature in the range of about 100-160° C. and then calcined for about 0.2-2 or 0.2-1.0 hrs at a temperature in the range of about 300-510° C.

13. A process for hydrocracking a hydrocarbonaceous feedstock, the process comprising contacting the catalyst of claim 1 with a hydrocarbonaceous feedstock under hydrocracking conditions.

14. The process of claim 13, wherein the process is a second stage hydrocracking process.

15. The process of claim 13, wherein the S and N content of the hydrocarbonaceous feedstock are individually or both less than about 200 ppm, or 150 ppm, or 100 ppm, or 50 ppm, or 20 ppm or 10 ppm or 5 ppm or 2 ppm or 1 ppm.

16. The process of claim 13, wherein the hydrocarbonaceous feedstock comprises a visbroken gas oil (VGB), heavy coker gas oil, gas oil derived from residue hydrocracking or residue desulfunzation, vacuum gas oil, thermally cracked oil, deasphalted oil, Fischer-Tropsch derived feedstock, FCC cycle oil, heavy coal-derived distillate, coal gasification byproduct tar, heavy shale-derived oil, organic waste biomass oil, pyrolysis oil, or a mixture thereof.

17. The process of claim 13, wherein the process provides a higher jet yield than a corresponding process using a non-bimetallic catalyst when both catalysts are separately contacted with the same hydrocarbonaceous feed under the same process conditions, wherein the non-bimetallic catalyst differs only in that it is not bimetallic and includes only platinum as the modifier metal.

18. The process of claim 13, wherein the process has a greater sulfur tolerance than a corresponding process using a non-bimetallic catalyst when both catalysts are separately contacted with the same hydrocarbonaceous feed under the same process conditions, wherein the non-bimetallic catalyst differs from the catalyst only in that it is not bimetallic and includes only platinum as the modifier metal.
